(19) United States
(12) Patent Application Publication
(10) Pub. No.: US 2008/0225442 A1
(43) Pub. Date: Sep. 18, 2008

(54) MAGNETIC HEAD

(75) Inventors: Koichi Hirose, Kawasaki (JP); Yoshiaki Shimizu, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/037,613

(22) Filed: Feb. 26, 2008

(30) Foreign Application Priority Data
Mar. 16, 2007 (JP) 2007-069150

(51) Int. Cl. G11B 5/33

(52) U.S. Cl. 360/319

(57) ABSTRACT

A magnetic head includes a magnetic sensor layer and upper and lower read shields sandwiching the magnetic sensor layer. At least one of the upper and lower read shields includes at least one end portion having a plurality of portions isolated in a core width direction of the magnetic sensor layer. The portions are isolated at least on an air bearing surface side. In this manner, edge noise can be suppressed even if external magnetic field noise or radio noise acts on the upper read shield, the lower read shield, the trailing shield, or the return yoke.

The present invention relates to a magnetic head having a magnetic sensor layer, and upper and lower read shields sandwiching the magnetic sensor layer, or having a main pole, and a trailing shield and a return yoke sandwiching the main pole.

### BACKGROUND OF THE INVENTION

FIGS. 1A and 1B are explanatory drawings showing a configuration of a conventional perpendicular magnetic recording head B. FIG. 1A is a plan view of the magnetic head B viewed from the side of an air bearing surface 90. FIG. 1B is a cross-sectional view of the magnetic head B cut by a plane perpendicular to the air bearing surface 90. It should be noted that an insulating layer is transparently shown in FIGS. 1A and 1B.

As shown in FIGS. 1A and 1B, the magnetic head B is provided with a magnetic read head 99 which is composed of a magnetic sensor layer (magnetoresistance effect element) 96, an upper read shield 95 and a lower read shield 97. The upper read shield 95 and the lower read shield 97 serve as upper and lower magnetic shield layers by sandwiching the magnetic sensor layer 96. The magnetic head B is further provided with a magnetic write head 98 which is composed of a main pole 92, a trailing shield 91, a return yoke 94, and a coil 93. The main pole 92 is sandwiched between the trailing shield 91 and the return yoke 94.

The electrical resistance of the magnetic sensor layer 96 changes depending on the magnetic information recorded on a magnetic recording medium facing the air bearing surface 90. The magnetic head E reads magnetic information of the magnetic recording medium by detecting an electrical resistance thereof. Additionally, current is applied to the coil 93 to generate a magnetic field passing through the main pole 92. The main pole 92 writes magnetic information onto the magnetic recording medium by emitting a magnetic field from a pole tip on the air bearing surface 90 side to the magnetic recording medium.

By the way, various kinds of external magnetic field noise and radio noise may affect a magnetic storage apparatus having a magnetic head and a magnetic recording medium. The upper and lower read shields 95 and 97, the trailing shield 91, and the return yoke 94 have magnetic properties and occupy a relatively large area in the magnetic head B. These serve as antennas for picking up external magnetic field noise and external radio noise. When the upper and lower read shields 95 and 97, the trailing shield 91, and the return yoke 94 pick up a strong external magnetic field noise, a strong magnetic field is generated at edge portions (corner portions) 94a thereof as shown in FIG. 2. When a strong magnetic flux (so called edge noise) is emitted from the edge portion 94a to a magnetic recording medium 88, this may cause a problem in that the magnetic information recorded on the magnetic recording medium 88 may be erased or overwritten. This phenomenon is generally referred to as an external magnetic field erasure.

It should be noted that FIG. 2 shows edge noise in the return yoke 94 as a representative of edge noise, but similar phenomena may occur in the trailing shield 91 and the upper and lower read shields 95 and 97.

In addition, in magnetic recording, a strong magnetic field is applied from the edge portion of the return yoke to a disk (magnetic recording medium). Japanese Patent Application Laid-open Publication No. 2004-127407 discloses a technique for forming a shape (curved shape or shape with the edge portion cut off) in which an edge portion of the return yoke facing the disk medium is farther away from the disk medium than the center portion of the return yoke (see paragraphs 0035 to 0033 and FIG. 4). This technique is provided, to prevent a phenomenon (side write) in which magnetic information recorded on a magnetic recording medium may be erased or overwritten.

According to the shape of the return yoke disclosed in Japanese Patent Application Laid-Open Publication No. 2004-127407, the technique is assumed to be also effective in preventing some edge noise due to external magnetic field noise and external radio noise described above.

According to the technique disclosed in Japanese Patent Application Laid-Open Publication No. 2004-127407, the return yoke is chamfered. However, the strength of the magnetic field occurring at the edge portion is not changed greatly, causing a problem in that the effect of decreasing edge noise cannot be obtained well enough.

There is another problem in that, as shown in FIG. 3, when an edge portion 94a of the return yoke 94 facing the magnetic recording medium 88 is chamfered, a newly formed edge portion 94b near the center portion by the chamfering may generate edge noise.

The problem is that, the more steeply chamfered to keep the edge portions 94a at both ends farther away from the magnetic recording medium 88, the more sharply pointed the edge portions 94b near the center portion are, and thus more likely the edge noise tends to occur from the edge portions 94b.

The present invention has been made to solve the above problems. It is an object of the present invention to provide a magnetic head capable of suppressing edge noise even if external magnetic field noise and radio noise act on the upper and lower read shields, the trailing shield or the return yoke.

### SUMMARY OF THE INVENTION

In accordance with an aspect of an embodiment, a magnetic head includes a magnetic sensor layer and upper and lower read shields sandwiching the magnetic sensor layer. At least one of the upper and lower read shields has at least one end portion comprising a plurality of portions isolated in a core width direction of the magnetic sensor layer. The portions are isolated at least on an air bearing surface side.

In addition, in accordance with an aspect of an embodiment, a magnetic head includes a main pole, a trailing shield and a return yoke. The trailing shield and the return yoke sandwich the main pole. At least one of the trailing shield and the return yoke has at least one end portion comprising a plurality of portions isolated in a core width direction of the main pole. The portions are isolated at least on an air hearing surface side.

### BRIEF DESCRIPTION OF THE DRAWINGS

The present invention will be explained with reference to the accompanying drawings.

FIG. 1A is a plan view of a conventional magnetic head viewed from the side of an air bearing surface.

FIG. 1B is a cross-sectional view of the magnetic head of FIG. 1A cut by a plane perpendicular to the air bearing surface.

FIGS. 2 and 3 are explanatory drawings of edge noise related to a conventional magnetic head.

FIG. 4A is a plan view of a magnetic head in accordance with a present embodiment viewed from the side of the air bearing surface.

FIG. 4B is a cross-sectional view of the magnetic head of FIG. 4A cut by a plane perpendicular to the air bearing surface.

FIG. 5 is an explanatory drawing of an upper read shield in accordance with a first embodiment viewed from a direction perpendicular to the film surface (thin film laminating direction).

FIG. 6 is an explanatory drawing of an upper read shield in accordance with a second embodiment viewed from a direction perpendicular to the film surface (thin film laminating direction).

FIG. 7 is an explanatory drawing of an upper read shield in accordance with a third embodiment viewed from a direction perpendicular to the film surface (thin film laminating direction).

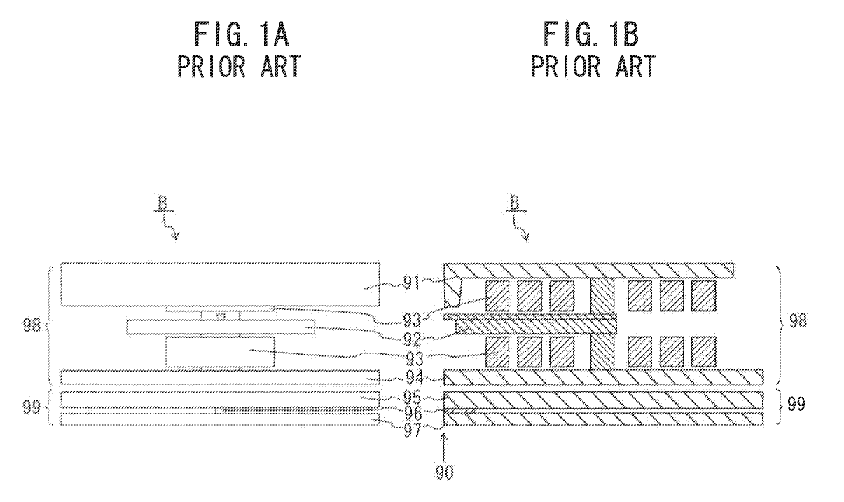

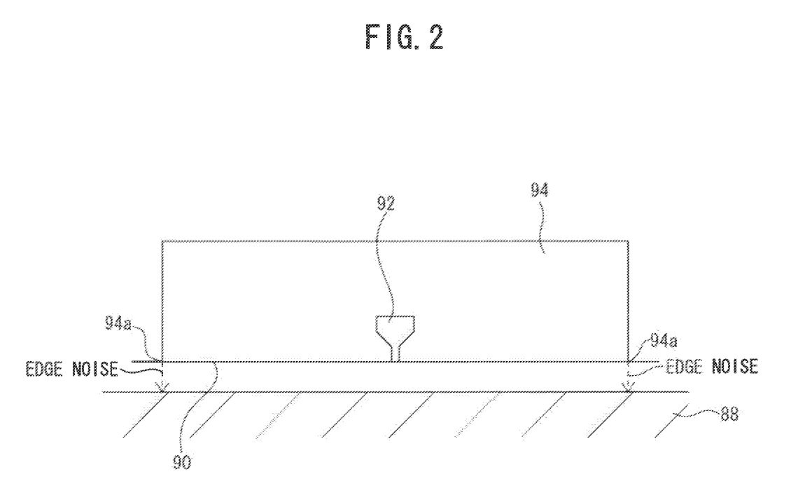

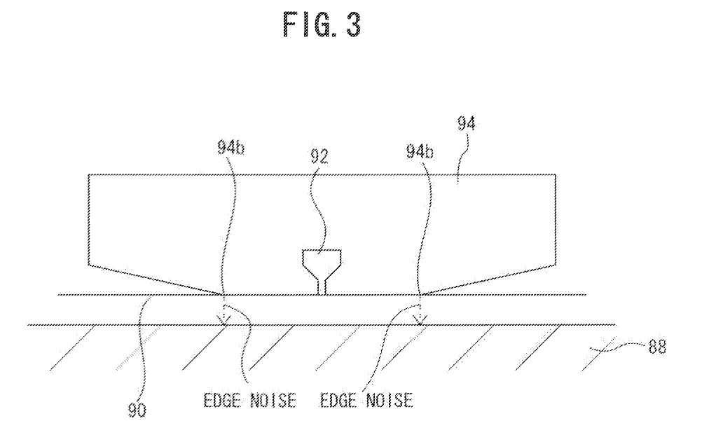

### DETAILED DESCRIPTION

Hereinafter, the preferred embodiments for implementing a magnetic head in accordance with the present invention will be described.

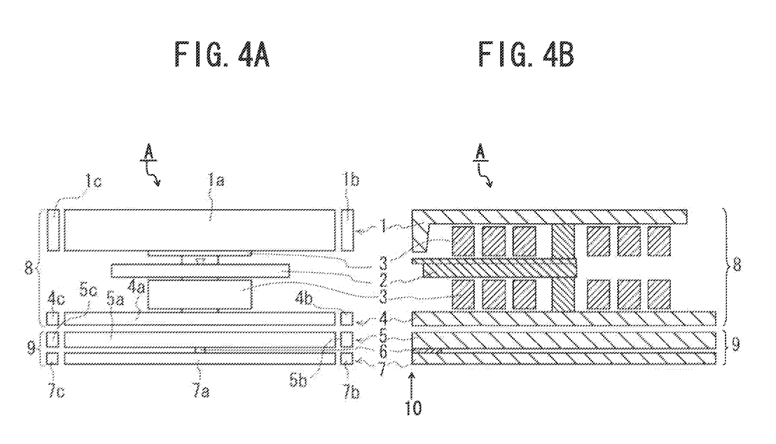

FIGS. 4A and 4B are an explanatory drawing showing a configuration of a perpendicular magnetic recording head A in accordance with the present embodiment. FIG. 4A is a plan view of the magnetic head B viewed from the side of the air bearing surface 10. FIG. 4B is a cross-sectional view of the magnetic head A cut by a plane perpendicular to the air bearing surface 10. It should be noted that an insulating layer is transparently [??] shown in FIGS. 4A and 4B.

As shown in FIGS. 4A and 4B, the magnetic head A is provided with a magnetic read head 9 which is composed of a magnetic sensor layer (magnetoresistance effect element) 6, an upper read shield 5 and a lower read shield 7. The upper read shield 5 and the lower read shield 7 serve as upper and lower magnetic shield layers by sandwiching the magnetic sensor layer 6. The magnetic head A is further provided with a magnetic write head 8 which is composed of a main pole 2, a trailing shield 1, a return yoke 4, and a coil 3. The main pole 2 is sandwiched between the trailing shield 1 and the return yoke 4.

The electrical resistance of the magnetic sensor layer 6 changes depending on the magnetic information recorded on a magnetic recording medium facing the air bearing surface 10. The magnetic head A reads magnetic information of the magnetic sensor layer 6 by detecting an electrical resistance thereof. Additionally, current is applied to the coil 3 to generate a magnetic field passing through the main pole 2. The main pole 2 writes magnetic information onto the magnetic recording medium by emitting a magnetic field from a pole tip on the air bearing surface 10 side to the magnetic recording medium.

The magnetic head A in accordance with the present embodiment is characterized by the configuration of the upper and lower read shields 5 and 7, the trailing shield 1, and the return yoke 4.

Hereinafter, embodiments 1 to 3 will be described as a plurality of configuration examples of the configuration of the upper and lower read shields 5 and 7, the trailing shield 1, and the return yoke 4.

According to a first embodiment, the upper read shield 5 is composed of three magnetic shield layers 5a, 5b, and 5c which are magnetically isolated in a core width direction of the magnetic sensor layer 6 (a horizontal direction in FIG. 4A, and a depth direction in FIG. 4B). The magnetic shield layers 5a, 5b, and 5c are disposed on the same film surface.

The magnetic shield layer 5a located in the center of the three magnetic shield layers 5a, 5b, and 5c is formed widest in the core width direction. The magnetic shield layers 5b and 5c located at both ends of the magnetic shield layer 5a are formed narrower than the magnetic shield layer 5a. In other words, the upper read shield 5 has portions 5b and 5c isolated in the core width direction at both ends thereof in the core width direction.

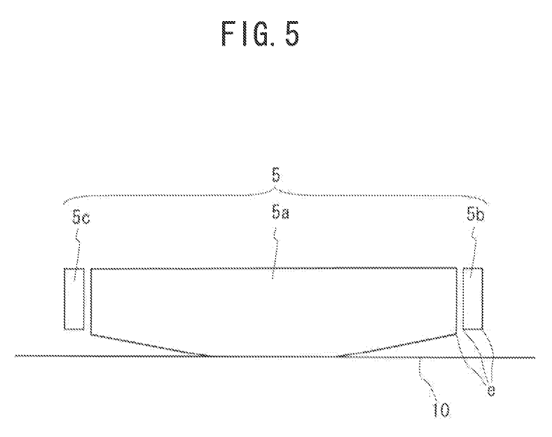

FIG. 5 is an explanatory drawing of the upper read shield 5 in accordance with the first embodiment viewed from a direction perpendicular to the film surface (thin film laminating direction).

The center portion of the upper read shield 5 in the core width direction (horizontal direction in FIG. 5) is exposed to the air bearing surface 10. The upper read shield 5 is formed such that a distance between the upper read shield 5 and the air bearing surface 10 is wider on the side closer to the ends of the upper read shield 5 in the core width direction.

Likewise, as shown in FIG. 4A, the lower read shield 7 is also composed of three magnetic shield layers 7a, 7b, and 7c which are magnetically isolated in the core width direction of the magnetic sensor layer 6. The description of the planar shape thereof is omitted since it is the same as described in the configuration of the upper read shield 5.

In addition, the trailing shield 1 is also composed of three trailing shield layers 1a, 1b, and 1c which are magnetically isolated in the core width direction of the magnetic sensor layer 6. The planar shape thereof is the same as described in the configuration of the upper read shield 5. Similarly, the return yoke 4 is also composed of three return yoke layers 4a, 4b, and 4c which are magnetically isolated in the core width direction of the magnetic sensor layer 6. The planar shape thereof is also the same as described in the configuration of the upper read shield 5.

As the upper read shield 5 is configured in this way, external magnetic field noise and radio noise are distributed over and received by a plurality of magnetically isolated magnetic shield layers 5a, 5b, and 5c. Further, there are many edge portions e at the end portions of the upper read shield 5 on the air bearing surface 10 side, and thus the magnetic field applied to each edge portion e is distributed and decreased. Accordingly, edge noise is suppressed and external magnetic field erasure is difficult to occur.

Similar advantages can also be obtained by applying a similar configuration to the lower read shield 7, the trailing shield 1, and the return yoke 4.

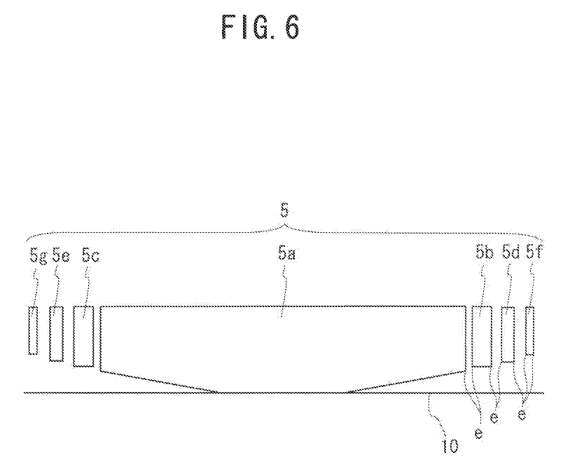

FIG. 6 is an explanatory drawing showing a configuration of the upper read shield 5 in accordance with a second embodiment. The upper read shield 5 in accordance with the second embodiment is composed of seven magnetic shield layers 5a, 5b, 5c, 5d, 5e, 5f and 5g which are magnetically isolated in a core width direction of the magnetic sensor layer 6. The magnetic shield layers 5a, 5b, 5c, 5d, 5e, 5f and 5g are disposed on the same film surface.

The magnetic shield layer 5a located in the center of the seven magnetic shield layers 5a to 5g is formed widest in the core width direction. Each of the magnetic shield layers 5b to 5g located at both ends of the magnetic shield layer 5a is formed narrower than the magnetic shield layer 5a respectively. In other words, the upper read shield 5 has many portions 5b to 5g isolated in the core width direction at both ends thereof located in the core width direction.

In addition, as shown in FIG. 6, the isolated portions 5b to 5g of the upper read shield 5 are formed so as to be different in size in the core width direction such that the isolated portions closer to the end of the upper read shield 5 in the core width direction are smaller (narrower).

Further, spaces between each of the isolated portions 5b to 5g of the upper read shield 5 in the core width direction are different in width such that the spaces closer to the end of the read shield in the core width direction are broader.

Further, in the same way as in the first embodiment, the center portion of the upper read shield 5 in a core width direction is exposed to the air bearing surface 10. The upper read shield 5 is formed such that a distance between the upper read shield 5 and the air bearing surface 10 is wider on the side closer to the ends of the upper read shield 5 in the core width direction.

According to the configuration in accordance with the second embodiment, external magnetic field noise and radio noise distributed over and received by a larger number of magnetically isolated magnetic shield layers 5a to 5g than in the first embodiment. Accordingly, edge noise is suppressed and external magnetic field erasure is less likely to occur.

Further, the isolated portions 5b to 5g of the upper read shield 5 are formed so as to be different in size in the core width direction such that the isolated portions closer to the end of the upper read shield 5 in the core width direction are smaller. Further, spaces between each of the isolated portions 5b to 5g in the core width direction are different in width such that the spaces closer to the end of the read shield in the core width direction are broader. With such configuration, noise can be more smoothly distributed over to each edge portion e corresponding to the each portion 5b to 5g.

According to the second, embodiment, similar advantages can also be obtained by applying a similar configuration to the lower read shield 7, the trailing shield 1, and the return yoke 4 (description omitted).

According to the first embodiment and the second embodiment, the isolated portions of the upper and lower read shields 5 and 7, the trailing shield 1, and the return yoke 4 are completely isolated from each other, and are disposed without being connected to each other. However, the configuration of the upper and lower read shields, the trailing shield, and the return yoke of the magnetic head in accordance with the present invention is not limited to this configuration, but includes any configuration having a plurality of end portions isolated at least on the air bearing surface side in the core width direction of the magnetic sensor layer.

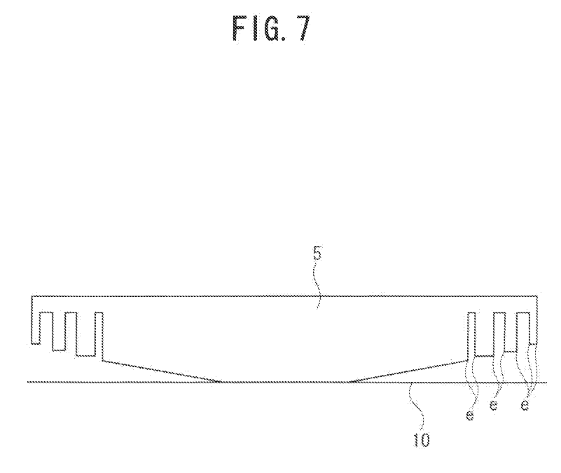

In the configuration of the upper read shield 5 in accordance with the third embodiment, as shown in FIG. 7, only the air bearing surface 10 side of the end portions of the upper read shield 5 is isolated to form a plurality of portions and the opposite surface thereof is continuous.

The configuration other than the above is the same as in the second embodiment. In other words, the configuration in accordance with the third embodiment is such that the opposite surface of the end portions of the upper read shield 5 on the air bearing surface 10 side is connected in the configuration of the second embodiment.

In addition, in the same way as in the first embodiment and the second embodiment, the center portion of the upper read shield 5 in a core width direction is exposed to the air bearing surface 10. The upper read shield 5 is formed such that a distance between the upper read shield 5 and the air bearing surface 10 is wider on the side closer to the ends of the upper read shield 5 in the core width direction. It should be noted that according to the third embodiment, in a comb-like portion of the end portions of the upper read shield 5 in the core width direction, the distance between the upper read shield 5 and the air bearing surface 10 is defined as the distance between each tip portion of the comb-like portion on the air bearing surface side and the air bearing surface 10. In other words, the distance corresponds to the distance between the portion excluding the valley portion of the comb-like portion of the upper read shield 5 and the air bearing surface 10.

According to the configuration in accordance with the third embodiment, the external magnetic field noise and radio noise received by the read shield 5 can also be distributed over a number of edge portions e. Accordingly, edge noise is suppressed and external magnetic field erasure is less likely to occur.

Heretofore, three embodiments have been described. However, the configuration of the upper read shield, the lower read shield, the trailing shield, and the return yoke does not need to be the same as that of each embodiment, but different configuration can be used.

In addition, the configuration in accordance with the present invention does not need to be applied to all of the upper read shield, the lower read shield, the trailing shield, and the return yoke, but any configuration in which the present invention is applied to at least one of the upper read shield, the lower read shield, the trailing shield, and the return yoke falls within the scope of the present invention.

The magnetic head in accordance with the present invention has an advantage in that, edge noise can be suppressed even if external magnetic field noise or radio noise acts on the upper read shield, the lower read shield, the trailing shield, or the return yoke.

What is claimed is:

1. A magnetic head comprising:
a magnetic sensor layer; and
upper and lower read shields sandwiching the magnetic sensor layer,
wherein at least one of the upper and lower read shields has at least one end portion comprising a plurality of portions isolated in a core width direction of the magnetic sensor layer, and
the portions are isolated at least on an air bearing surface side.

2. The magnetic head according to claim 1, wherein the isolated portions of the read shield are formed so as to be different in size in the core width direction, and
the isolated portions closer to an end of the read shield in the core width direction are smaller.

3. The magnetic head according to claim 1, wherein spaces between each of the isolated portions of the read shield in the core width direction are different in width, and
the spaces closer to the end of the read shield in the core width direction are broader.

4. The magnetic head according to claim 2, wherein spaces between each of the isolated portions of the read shield in the core width direction are different in width, and
the spaces closer to the end of the read shield in the core width direction are broader.

5. The magnetic head according to claim 1, wherein the upper read shield is formed such that center portions of the upper read shield in the core width direction are exposed to the air bearing surface, and
a distance between the upper read shield and the air bearing surface is greater on a side closer to ends of the read shields in the core width direction than a distance between the center portions and the air bearing surface.

6. The magnetic head according to claim 2, wherein the upper read shield is formed such that center portions of the upper read shield in the core width direction are exposed to the air bearing surface, and
a distance between the upper read shield and one air bearing surface is greater on a side closer to ends of the read shields in the core width direction than a distance between the center portions and the air bearing surface.

7. The magnetic head according to claim 3, wherein the upper read shield is formed such that center portions of the upper read shield in the core width direction are exposed to the air bearing surface, and
a distance between the upper read shield and the air bearing surface is greater on a side closer to ends of the read shields in the core width direction than a distance between the center portions and the air bearing surface.

8. The magnetic head according to claim 4, wherein the upper read shield is formed such that center portions of the upper read shield in the core width direction are exposed to the air bearing surface, and
a distance between the upper read shield and the air bearing surface is greater on a side closer to ends of the read shields in the core width direction than a distance between the center portions and the air bearing surface.

9. The magnetic head according to claim 1, wherein the lower read shield is formed such that center portions of the lower read shield in the core width direction are exposed to the air bearing surface, and
a distance between the lower read shield and the air bearing surface is greater on a side closer to ends of the read shields in the core width direction than a distance between the center portions and the air bearing surface.

10. The magnetic head according to claim 2, wherein the lower read shield is formed such that center portions of the lower read shield in the core width direction are exposed to the air bearing surface, and
a distance between the lower read shield and the air bearing surface is greater on a side closer to ends of the read shields in the core width direction than a distance between the center portions and the air bearing surface.

11. The magnetic head according to claim 3, wherein the lower read shield is formed such that center portions of the lower read shield in the core width direction are exposed to the air bearing surface, and
a distance between the lower read shield and the air bearing surface is greater on a side closer to ends of the read shields in the core width direction than a distance between the center portions and the air bearing surface.

12. The magnetic head according to claim 4, wherein the lower read shield is formed such that center portions of the lower read shield in the core width direction are exposed to the air bearing surface, and
a distance between the lower read shield and the air bearing surface is greater on a side closer to ends of the read shields in the core width direction than a distance between the center portions and the air bearing surface.

13. A magnetic head comprising:
a main pole;
a trailing shield; and
a return yoke,
wherein the trailing shield and the return yoke sandwich the main pole, and at least one of the trailing shield and the return yoke has at least one end portion comprising a plurality of portions isolated in a core width direction of the main pole, and
the portions are isolated at least on an air bearing surface side.

14. The magnetic head according to claim 13, wherein the isolated portions of the trailing shield are formed so as to be different in size in the core width direction, and
the isolated portions closer to an end of the trailing shield in the core width direction are progressively smaller than adjacent isolated portions further from the end.

15. The magnetic head according to claim 14, wherein spaces between each of the isolated portions of the trailing shield in the core width direction are different in width, and
the spaces closer to the end of the trailing shield in the core width direction are progressively broader than adjacent spaces further from the end.

16. The magnetic head according to claim 13, wherein the isolated portions of the return yoke are formed so as to be different in size in the core width direction, and
the isolated portions closer to an end of the return yoke in the core width direction are progressively smaller than adjacent isolated spaces further from the end.

17. The magnetic head according to claim 16, wherein spaces between each of the isolated portions of the return yoke in the core width direction are different in width, and
the spaces closer to the end of the return yoke in the core width direction are progressively broader than adjacent spaces further from the end.

18. The magnetic head according to claim 13, wherein the trailing shield is formed such that a center portion of the trailing shield in the core width direction is exposed to the air bearing surface, and
a distance between the trailing shield and the air bearing surface is greater on a side closer to the end of the trailing shield in the core width direction than a distance between the center portions and the air bearing surface.

19. The magnetic head according to claim 13, wherein the return yoke is formed such that a center portion of the return yoke in the core width direction is exposed to the air bearing surface, and
a distance between the return yoke and the air bearing surface is greater on a side closer to the end of the return yoke in the core width direction than a distance between the center portions and the air bearing surface.
